(19) United States
(12) Patent Application Publication
(10) Pub. No.: US 2001/0054209 A1
(43) Pub. Date: Dec. 27, 2001

(54) DYEING OF TEXTILES

(76) Inventors: GEOFFREY WILLIAM COLLINS, WIRRALL (GB); STEPHEN MARTIN BURKINSHAW, WETHERBY (GB); ROY GORDON, CLEVELAND (GB)

Correspondence Address: PILLSBURY MADISON & SUTRO LLP, 1100 NEW YORK AVENUE, N.W. NINTH FLOOR, WASHINGTON, DC, 20005-3918, US

(21) Appl. No.: 09/379,287

(22) Filed: Aug. 23, 1999

Related U.S. Application Data
(63) Continuation of application No. PCT/GB98/00499, filed on Feb. 18, 1998.

(30) Foreign Application Priority Data
Feb. 24, 1997 (GB) 9703813.7

(51) Int. Cl. D06P 1/00; D06P 3/82; C09B 62/00; C09B 62/04; C09B 67/00

(52) U.S. Cl. 8/495; 8/532; 8/533; 8/543; 8/549; 8/554; 8/555; 8/918; 8/921; 8/930

(57) ABSTRACT

A method for dyeing cellulosic materials with reactive dye by pretreating the fabric with a polycationic polymeric agent which is desirably also polynucleophilic is disclosed. The agent can be a polyquaternary amine material especially a poly(DADMAC) or polyvinylpyridine, particularly one including nucleophilic sites such as primary amino groups, e.g. polyallylamine/DADMAC copolymers and polyvinylpyridines quaternisied with w-aminoalkyl groups. The dyes can react with the nucleophilic centres so dyebath exhaustion can be driven by dye fixation rather than substantivity to the substrate. The need to use of salts to drive substantivity can be obviated and post dyeing washing to remove unreacted/hydrolysed dye is much simplified. Material dyed by the method has the good wash fastness properties of materials dyed using reactive dyes. A wide variety of cellulosic substrates can be dyed including lyocell fibre materials and blend/union materials with polyamides.

This information relates to the dyeing of textiles, and in particular to the dyeing of pre-treated cellulosic textiles using reactive dyes.

It is well known that cellulosic textiles can be dyed with reactive dyes. Reactive dyes have groups that form covalent bonds with the cellulose molecules. A significant difficulty in using reactive dyes on cellulosic textiles is that reactive dyes are not naturally strongly substantive to cellulose so that large amounts of salts e.g. NaCl, are used to encourage deposition of the dye onto the textile. Even with the use of salt, complete exhaustion of the dyebath is not obtained so that substantial amounts of dye are left in the dyebath, thus yielding an effluent which is both highly coloured and has a high electrolyte loading.

The present invention is based on our discovery that by using a suitable pretreatment the cellulosic fibres can be modified so that reactive dyes are substantive to the cellulose without electrolyte addition to the dyebath. Further, residual reactive dye and hydrolysed dye (which is often formed because for many reactive dyes on cellulosic substrates, the dyeing is carried out under alkaline conditions) needs to be removed from the fabric after dyeing by often prolonged and complex wash off procedures. Failure to carry out this post-dyeing washing thoroughly generally leads to poor wash fastness and adjacent fabric staining during washing in normal use). This pretreatment can be applied to cotton and similar cellulosic substrates, including regenerated cellulosics such as rayon and lyocell materials, to give well dyed products with excellent wash fastness and good (low) staining of adjacent fabrics in normal washing in use.

Accordingly, the present invention provides a method of making a dyed cellulosic fibrous textile material, which includes the steps of:

1 treating the material with a polymeric pretreatment agent having a plurality of cationic centres and desirably also a plurality of nucleophilic centres;

2 dyeing the material with a reactive dye; and

3 optionally treating the material with a cationic polymer.

The substrate treated in this invention is described as a fibrous cellulosic textile material. By this we mean that the substrate is cellulosic or contains, typically, from 30 to 100% fibres of, cellulosic material. Typical cellulosic fibre materials which can be included in such fabrics include natural cellulosic fibrous material such as cotton, flax, jute, hemp and ramie, and synthetic or regenerated cellulosic fibrous material such as rayon particularly viscose and acetate rayon and solvent spun materials, particularly where the solvent is N-methylmorpholine oxide (NMMO) which are often referred to as lyocell materials and in particular the lyocell fibre from Courtaulds and the fabrics made from such fibre sold under the Courtaulds trade name ‘Tencel’. The cellulosic fibre material can be a blend on more than one type of cellulosic fibre or a blend of fibres of cellulosic fibres with non-cellulosic materials and in particular includes blends of cellulosic fibres, particularly cotton, rayon and, especially, lyocell, fibre with polyester, particularly polyethylene terephthalate polymer or related copolymer, fibre, or with polyamide fibres, including wool, silk and synthetic polyamides such as nylon. The textile can be a woven (including knitted) or non-woven textile, but will usually be a clothing textile material.

The polymeric pretreatment agent used in the invention is cationic and such materials are referred to as cationic polymeric pretreatment agents. The cationic polymeric pretreatment agents are polymer including a plurality of cationic centres and are usually made by polymerisation of monomers containing cationic or potentially cationic centres. Desirably the cationic centres are quaternary nitrogen centres which may be aliphatic quaternary ammonium groups or quaternary aromatic nitrogen centres. The quaternary nitrogen centre may be present as such in the polymeric agent or may be present under application conditions or may be generated in situ after application to the textile. Examples of cationic quaternary nitrogen centres which can be present in the polymeric pretreatment agent include: —N⁺(R)₃ where each R is an alkyl group particularly a C₁ to C₄ alkyl e.g. methyl group, although one or more of the R groups may be a longer chain alkyl group e.g. a C₆ to C₁₈ alkyl group, or where two of the groups R together with the nitrogen atom bearing them form a heterocyclic ring, particularly a 5 or 6 membered ring, which may include further hetero atoms, such as piperidine, tetrahydropyrrole, piperazine and morpholine rings, which may themselves be further suited as in N-alkyl e.g. methyl, piperazine rings; or one of the R groups may be a group, typically an alkylene group, linking to another, usually nitrogen, site in the polymer or to another polymer chain; or −N⁺(R′)₂- where the groups R′ are as defined for R above and the other bonds directly or indirectly link into the polymer chain optionally via a ring, usually a 5- or 6-membered ring; and aromatic quaternary nitrogen centres such as pyridinium.

The degree of cationicity (expressed as cationic centres per units of molecular weight) is generally at least 1 cationic, particularly quaternary nitrogen centre, per 1500 Daltons (D), desirably at least 1 cationic centre per 1000 D, more usually at least 1 cationic centre per 750 D and with the most effective polymers we have tested at least 1 cationic centre per 500 D. The maximum concentration of cationic centres is about 1 per 120 D, desirably not more than about 1 per 150 D.

Expressed as cationic centres per monomer residue in the polymer, the polymer typically has at least about 1 cationic centre per 20, more usually at least about 1 cationic centre per 10, and desirably at least about 1 cationic centre per 5, monomer residues in the polymer. For a polymer which is cationic but not nucleophilic the upper limit is typically 1 cationic centre per monomer residue.

Examples of cationic polymeric pretreatment agents include polymers of diallyidimethylammonium chloride (which polymerises to give a repeat unit including cyclic, 5- and/or 6-membered ring including dimethyl ammonium groups)—conveniently referred to under the abbreviation poly-DADMAC (diallyidimethylammonium chloride) such as is available under the trade name Matexil FC-ER from ICI Surfactants, quaternised (co-)polymers of vinylpyridines, such as 4-vinylpyridine, copolymers of dimethyl amine and epi-chlorohydrin such as is available under the trade name Fixogene CXF from ICI Surfactants and copolymers of diallyidimethylammonium and diallyl-N-2-hydroxy-3-chloro-propylamine (or its protonated ammonium derivative) and copolymers having repeat units of diallylmethylamine (or its protonated ammonium derivative) and diallyl-N-methyl-N2-hydroxyl-3-chloropropylammonium. The charge balancing anions for the quaternary ammonium groups are typically halide, particularly chloride, ions. These latter two copoplymers are capable of crosslinking or similar reactions involving the chloride substituent on the propyl group and other nitrogen centres.

The use of cationic polymeric pretreatment agents has the advantage that they are strongly substantive to the cellulosic fibres, and are thus readily applied to the textiles, and typical reactive dyes are substantive to the treated cellulosic textile material. This can substantially ease application of the dyes to the cellulosic textile material for example reducing or eliminating the need for the use of salts to encourage substantivity and making it possible to operate to high dye solution exhaustion. However, the cationic polymeric pretreatment agents do not generally make the cellulosic textile material more reactive towards the dyestuffs so that the conditions for reaction between the cellulose and the dyestuff will be those typically used for the respective reactive dyes on cellulose and there remains the need for thorough washing out of the dyed fabric to remove unreacted and/or hydrolysed reactive dye.

The polymeric pretreatment agent desirably has both a plurality of cationic centres and a plurality of nucleophilic centres and such materials are known as cationic nucleophilic polymeric pretreatment agents. Typically, cationic nucleophilic polymeric pretreatment agents will be polymers of monomers containing at least one cationic (or potentially cationic) centre and containing a nucleophilic group. The cationic centre and nucleophilic group can be in the same or different monomer units. Yet other monomers can be included e.g. substantially inert monomers to regulate the cationicity and/or nucleophilicity of the cationic nucleophilic polymeric pretreatment agents.

The nucleophilic centres can be strongly nucleophilic groups as such or groups that are relatively weak nucleophilic centres in themselves, but are promoted by other groups on the pretreatment agent. The nucleophilic centres are desirably relatively strong nucleophiles that react readily with the reactive dye. As is described later, the inclusion of nucleophilic centres enable the use of less vigorous conditions for dyeing so the nucleophilic centres are desirably relatively strong nucleophiles under neutral or relatively mildly alkaline aqueous conditions e.g. from pH 6 to 9 and particularly from 6 to 7.5. Examples of relatively strong nucleophilic centres include primary amino groups, especially primary aliphatic amino groups as these are more reactive than aromatic primary amino groups, secondary aliphatic amino groups and thiol groups. Examples of relatively weak nucleophilic centres that can be promoted by other groups on the pretreatment agent include activated hydroxyl groups, especially primary aliphatic hydroxyl groups, beta to a quaternary ammonium group which activates the hydroxyl group e.g. 2-hydroxyethyl(quaternary)ammonium groups.

The cationicity of the cationic nucleophilic polymeric pretreatment agents is typically similar to that of the cationic polymeric pretreatment agents as described above. However, the maximum cationicity is generally somewhat lower as the inclusion of nucleophilic centres increases the molecular weight per cationic centre. The degree of cationicity (expressed as cationic centres per units of molecular weight) is generally at least 1 cationic, particularly quaternary nitrogen centre, per 1500 D, desirably at least 1 cationic centre per 1000 D, more usually at least 1 cationic centre per 750 D and with the most effective polymers we have tested at least 1 cationic centre per 500 D. The maximum concentration of cationic centres is typically about 1 per 180 D more usually about 1 per 200 D.

Expressed as cationic centres per monomer residue in the polymer, the polymer typically has at least about 1 cationic centre per 20, more usually at least about 1 cationic centre per 10, and desirably at least about 1 cationic centre per 5, monomer residues in the polymer. For a polymer which is cationic but not nucleophilic the practical upper limit is typically 1 cationic centre per monomer residue, but more usually the cationicity will be lower than this e.g. 3 cationic centres per 4 monomer residues as in quaternised vinyl pyridines and 1 cationic centre per 2 monomer residues as in a polymer made from equal molar proportions of cationic and nucleophilic monomers.

The concentration of nucleophilic centres in the polymer (expressed as nucleophilic centres per units of molecular weight) is generally at least 1 nucleophilic centres per 1500 D, desirably at least 1 per 1000 D, more usually at least 1 per 750D and with the most effective polymers we have tested at least 1 per 500 D. The maximum concentration of nucleophilic centres is about 1 per 60 D, more usually about 1 per 70 D and most usually about 1 per 100 D. Expressed as nucleophilic centres per monomer residue in the polymer, the polymer typically has at least about 1 nucleophilic centres per 20, more usually at least about 1 per 10, and desirably at least about 1 per 5, monomer residues in the polymer. The practical upper limit is typically 1 nucleophilic centres per monomer residue e.g. where the monomer residues carry both nucleophilic and cationic centres, but more usually as the polymer will often carry the cationic and nucleophilic centres on residues of different monomers, in this case, the maximum number of nucleophilic centres will be lower than this e.g. 9, and more usually 8, nucleophilic centres per 10 monomer residues.

The use of cationic nucleophilic polymeric pretreatment agents shares the advantages of cationic polymeric pretreatment agents that they are strongly substantive to the cellulosic fibres, and are thus readily applied to the cellulosic textile material. In addition, the presence of the nucleophilic centres in these pretreatment agents makes the reaction between the treated cellulosic textile material and the reactive dyestuffs (believed to be between the nucleophilic centres on the pretreatment agent and the reactive dyestuff) possible under milder conditions than is normally possible for most reactive dyes on cellulosic substrates. Indeed, where the nucleophilic centres are themselves highly reactive towards the reactive dyes, especially where the nucleophilic centres are or include aliphatic primary amino groups, the ease of reaction between the dye and the treated cellulosic textile material can drive the exhaustion of the dye onto the fabric, even where the reactive dye is itself not strongly substantive to the treated cellulosic textile material.

The cationic polymeric pretreatment agents and cationic nucleophilic polymeric pretreatment agents used in this invention typically have molecular weighs of from 5 to 50 kD (klaoDaltons) and more desirably from 10 to 30 kD).

The cationic nucleophilic polymeric pretreatment agents can be made from a variety of monomeric units. Cationic sites can be provided by ethylenically unsaturated monomers containing cationic centres e.g. quaternary nitrogen atoms, or centres that can be converted into quaternary nitrogen atoms e.g. primary, secondary or tertiary amino groups that can be quaternised, or halogen atoms that can be replaced (directly or indirectly) with quaternary nitrogen atoms. Nucleophilic sites can be provided by ethylenically unsaturated monomers containing nucleophilic centres e.g. particularly primary or secondary amino groups, thiol groups or activated hydroxyl groups, especially aliphatic hydroxyl groups beta to a quaternary ammonium group.

Examples of cationic nucleophilic polymeric pretreatment agents include copolymers of DADMAC and ethylenically unsaturated monomers containing a primary amino group such as allylamine (3-aminoprop-1-ene); poly(N-methyl-N-(aminoalkyl)diallylammonium, where the aminoalkyl group is e.g. 2-aminoethyl or 3-aminopropyl; polymers of vinylpyridine e.g. 4-vinylpyridine, quaternised with groups, particularly alkyl groups, containing a primary amino group e.g. quaternised with a 2-aminoethyl group, in effect copolymers of the vinylpyridine and the quaternised vinylpyridine; and copolymers having repeat units of diallylmethylamine (or its protonated ammonium derivative) and diallyl-2-hydroxyl-3-chloropropyl amine (or its protonated ammonium derivative).

Quaternisation of vinylpyridines such as 4-vinylpyridine can be carried out using conventional techniques to an extent of about 75% of the available aromatic nitrogens. Quatemisation can be with mixed groups e.g. alkyl groups and aminoalkyl groups, to vary the ratio of cationic to nucleophilic sites. However, unless the quaternising agent has a plurality of nucleophilic sites, and as one cationic site is generated for each quaternisation reaction, the ratio of cationic to nucleophilic sites will not generally be greater than 1.

Copolymers of ethylenically unsaturated monomers containing a quaternary nitrogen atom e.g. DADMAC, and ethylenically unsaturated monomers containing a primary amino group e.g. allylamine, can be made with varying ratios of cationic to nucleophilic sites by varying the proportions of the starting monomers. In such copolymers we have found that the performance is generally better where the ratio of nucleophilic to cationic centres is at least 1 to 1 and particularly from 1 to 1 to 5 to 1, e.g. about 3 to 1. Especially with such materials we have observed that the exhaustion of the dye onto the cellulosic textile material seems to be driven by fixation of the dye (presumably mainly to the cationic nucleophilic polymeric pretreatment agent) so there is only relatively little dye on the fibre in unreacted form. This seems to simplify post dyeing washing even further. Copolymers of ethylenically unsaturated monomers containing a quaternary nitrogen atom and ethylenically unsaturated monomers containing a primary amino group, in particular copolymers of allylamine and DADMAC and similar polymers are highly desirable pretreatment agents.

The pretreatment of the fabric with the polymeric pretreatment agent can be carried out by immersing the fabric in an aqueous solution or dispersion of the pretreatment agent at temperatures of up to about 130° C. e.g. up to about 100° C., particularly from 20 to 80° C., for a period of up to 2 hours, particularly from 15 minutes to 1 hour, e.g. from 20 to 30 minutes. Temperatures of about 40° are particularly appropriate for cotton and similar natural cellulosic materials although higher temperatures may be used. Temperatures of about 60 to about 80° C. are particularly appropriate for synthetic cellulosic materials such as rayon and lyocell materials, because the polymer is generally more crystalline than in natural cellulosic materials, although again higher temperatures may be used.

The concentration of the pretreatment agent in the treatment bath is desirably from 0.1 to 3%, particularly 0.25 to 2% and especially from 0.5 to 1%, by weight of 100% active pretreatment agent based on the dry weight of the fabric being pretreated. (Note—the pretreatment agents are typically supplied as 30 to 35% active aqueous solutions and this will be taken into account in determining the amount of the particular product used.) The liquor ratio (the ratio of the treatment/dye solution used to dry cloth weight) for pretreatment is typically from 5 to 25 desirably about 10. The pretreatment solution is typically at about neutral pH typically from 6 to about 8. More acidic treatment solutions may be appropriate when needed to ensure that the cationic groups in the pretreatment agent are cationic e.g. when they are amino groups that are ‘quaternised’ with protons from an acid medium.

The pretreatment can also be carried out by padding at ambient temperature using concentrations and pH values similar to those described above to give pick up typically about 70 to 150% by weight based on the dry fibre weight with padding, followed by drying typically at from about 80 to about 150° C., more usually from about 80 to about 120° C.

Reactive dyes are dyes which include a reactive centre which will react with a nucleophilic group (conventionally on the material of the textile being dyed) to form a covalent bond which strongly bonds the dye to the fibre. The reactive centre is typically an electronic centre, often associated with a good leaving group, and is often an activated carbon atom having a leaving group e.g. a halogen atom such as chlorine or fluorine, bonded to it, or a carbon atom in an activated double bond. Examples include triazine residues (2,4,6-trihalo-sym-triazinyl) carrying leaving groups such as halogen e.g. chlorine and/or fluorine, substituents, or other leaving groups such as N-linked nicotinic acid, halogen e.g. chlorine and/or fluorine, substituted pyrimidine groups, and activated ethylenic double bonds such as vinyl sulphone groups as in β-sulphatovinyl sulphone groups, and acrylic groups such as acrylamido groups particularly halogen e.g. bromine, substituted acrylamido groups. Reactive dyestuffs can include more than one such group and may have more than one such type of group.

Examples of these classes of dyestuffs include: Procion type dyes which included a cyanuryl chloride residue which may: have one remaining chlorine atom such as Procion P dyes (mono-monochlorotriazine dyes):

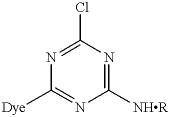

examples include Colour Index (Cl) Reactive Red 3:1 which has one cyanuryl chloride residue having one remaining chlorine atom one dye group:

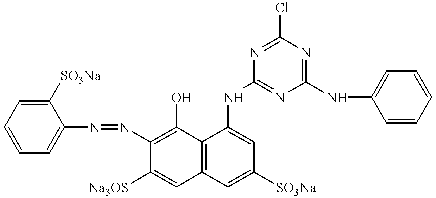

Cl Reactive Orange 12, Navy P-2R, Scarlet P-2R, Cl Reactive Blue 49, Cl Reactive Blue 71, Black P-2R and Cl Reactive Orange 13;

Procion H-EXL type dyes which have two cyanuryl chloride residues each having one remaining chlorine atom:

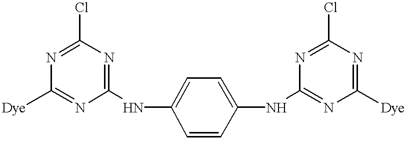

such as Procion H-EXL Blue, Yellow and Crimson and Cl Reactive Red 120:

(Cl Reactive Red 120 can be considered as a quasi-dimer of Cl Reactive Red 3:1); dyes including cyanuryl chloride residues having two remaining chlorine atoms such as Procion MX type:

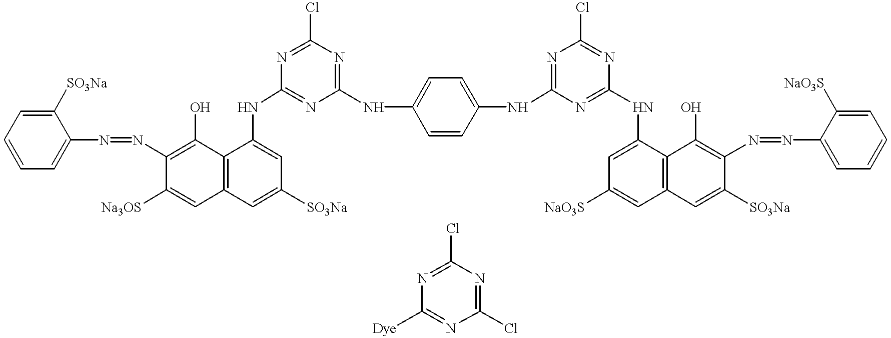

such as Cl Reactive Blue 163, Cl Reactive Yellow 22 and Cl Reactive Red 11; dyes including halo-pyrimidine residues such as Drimarene/Drimalan type dyes:

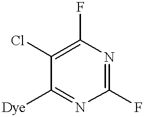

such as Drimalan Blue FG;

dyes containing β-sulphatovinyl sulphone groups such as the Remazol type dyes: containing one such group:

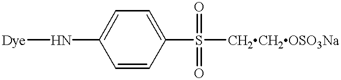

and containing two such groups:

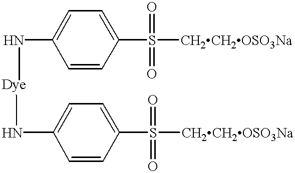

such as Remazol Red RR, Yellow RR, Blue RR and Cl Reactive Black 5;

dyes containing both cyanuryl chloride and β-sulphatovinyl sulphone groups such as the Sumifix Supra type dyes:

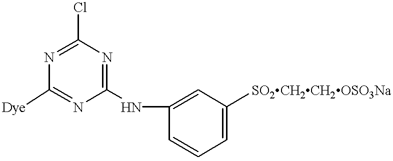

such as Sumifix Supra Yellow 3RF, Brilliant Red 3BF and Blue BRF and Yoracron Yellow BF-3R, Red BF-3B and Blue BF-R;

dyes containing N-linked nicotinic acid substituted 2,4,6-trichloro-sym-triazinyl residues such as the Kayacelon type dyes:

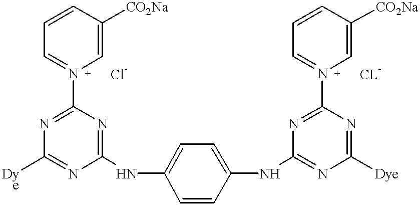

such as Kayacelon Blue CN-BL, Golden Yellow CN-GL and Cl Reactive Red 221;

and dyes including haloacrylic residues such as the Lanasol type:

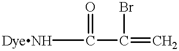

such as Cl Reactive Yellow 39, Cl Reactive Blue 69 and Cl Reactive Red 84. Reactive premetallized dyes such as 2:1 symmetrical reactive acid dyes including an acrylamido group: —NH.C(O)CH═CH₂, such as Cl Reactive Red 169.

In the formulae of these dyestuffs given above the groups labelled “Dye” are the chromophoric dye residues, which typically include sulphonate or other anionic centres. The reactive groups and the groups linking them to the Dye groups are typically chosen so that they interfere little with the colour produced by the dye chromophore.

The conditions of dyeing will depend on the nature of the reactive dye and of the pretreatment applied to the cellulosic textile material. Where the pretreatment agent is a cationic polymeric pretreatment agent the dyeing conditions will be those typically used for the respective reactive dyes on cellulose. In this case, where the reactive group in the dye is a halotriazine residue, a halopyrimidine residue or a vinyl sulphone group, the dyeing conditions will typically be strongly alkaline (pH typically 10.8 to 11.2) and the dyeing temperature typically 60° C. or higher. However, where the reactive group in the dye is a N-linked nicotinic acid substituted triazine residue, the dyeing conditions may be near neutral.

Where the pretreatment agent is a cationic nucleophilic polymeric pretreatment agent the dyeing will typically be carried out at near neutral pH e.g. from about 6 to about 8, although more alkaline conditions can be used. The temperature will be appropriate for the reactive dye type and will typically be from about 60° C. to about 130° C. e.g. about 60° C. to about 100° C. The use of conditions near neutral pH has the major advantage that hydrolysis of the reactive dye is kept to a minimum. In practice we have been able to operate with substantially no hydrolysis of the reactive dye. The dyebath will typically contain no significant amount of electrolyte as it is not needed to drive substantivity to the pretreated cellulosic textile material. Thus, typically, the dyebath is an aqueous solution of the dye and after dyeing contains residual reactive dye with no significant amount of hydrolysed dye or electrolyte and can thus readily be re-used.

The amount of dye used, the concentration of dye in the dyebath and the amount applied to the textile, will depend on the dye itself and the desired intensity of dyeing.

Conventionally, after dyeing cellulosic textile material with reactive dyes, it is necessary to remove any unbound e.g. unreacted or hydrolysed, reactive dye from the cellulosic textile material. In this invention, where the pretreatment is done using a cationic polymeric pretreatment agent, this post-dyeing washing will generally need to be conventional and thorough. Indeed, as the dyes may be substantive to the treated cellulosic textile material, it may need to be more thorough than in conventional systems. However, where the pretreatment is done using a cationic nucleophilic polymeric pretreatment agent, we have found that much milder post-dyeing washing conditions can be used, especially where the ability of the present method to successfully use dyes that are weakly substantive to the treated cellulosic textile material is exploited so that any remaining dye can be readily removed by washing. In this case, especially, the need for post-dyeing washing is much less than with conventional reactive dyes on cellulosic textile materials. Indeed, the post-dyeing washing can be a relatively simple and short rinse e.g. for 10 to 30, especially 15 to 20, minutes in water or a relatively mildly alkaline e.g. pH 7 to 10.5, aqueous solution which may include a detergent at moderate temperatures e.g. 50 to 100° C., especially 70 to 85° C. This mild post-dyeing washing contrasts strongly with typical post dyeing washing in conventional reactive dyeing processes on cellulosic textile materials.

After dyeing the cellulosic textile material can be further treated with a cationic polymer. The cationic polymer used for such a post treatment will generally be of the same type as the cationic polymeric pretreatment agents or the cationic nucleophilic polymeric pretreatment agents as described above, referred to in this context as cationic polymeric post-treatment agents. Similarly, the treatment conditions, concentrations and amounts are within the general and specific ranges set out above for the cationic polymeric pretreatment agents. The cationic polymeric post-treatment agents are substantive to the cellulosic textile material and we believe that they form a coating or layer over the dye on the cellulosic textile material (whether bound chemically to the cellulosic textile material or to the cationic nucleophilic polymeric pretreatment agent or unbound) and this can further improve the wash fastness of the dyeing and may reduce any tendency of the reactive dye to migrate in washing onto other co-washed materials. The treatment with cationic polymeric post-treatment agents will typically be carried out after post-dyeing washing to avoid trapping unreacted or hydrolysed dye on the cellulosic textile material. If a cationic polymeric post-treatment agent including a group reactive to other parts of the cationic polymeric post-treatment agents or to the cationic polymeric pretreatment agent or the cationic nucleophilic polymeric pretreatment agent is used, it is possible to generate higher molecular weight species by linking, crosslinling and polymerisation. This may further enhance the wash fastness of the dyed fabric. An example of such reactive cationic polymeric post-treatment agents are copolymers having repeat units of diallymethylamine (or its protonated ammonium derivative) and diallyl-2-hydroxyl-3-chloropropyl amine (or its protonated ammonium derivative). However, where optimised pretreatment and dyeing according to the invention is used, aftertreatment is not needed to improve the wash fastness of the dyeing.

Using the pretreatment step according to the invention, we have successfully obtained good dyed products having excellent wash fastness and staining of adjacent fabrics in washing in normal use as compared with conventional reactive dyed cellulosic textile materials. As is mentioned above, where the pretreatment step uses a cationic nucleophilic polymeric pretreatment agents, the advantages over conventional reactive dyeing systems on cellulosic textile materials can include good exhaustion onto the fabric without having to use salts to drive exhaustion, relatively mild dyeing and fixing conditions for a wide range of reactive dyes, the ability to use reactive dyes that are not conventionally usable on cellulosic materials such as the haloacrylamide type reactive dyes, and a much reduced need for post dyeing washing to remove unreacted/hydrolysed dyes. Where the pretreatment step uses a cationic polymeric pretreatment agent the dyeing and fixing steps are carried out under broadly conventional conditions for reactive dyes on cellulosic textile materials and there will generally be a greater need for post dyeing washing than is possible where the pretreatment step uses a cationic nucleophilic polymeric pretreatment agent.

The improved dyeing of reactive dyes to cellulosic textile materials obtained in the present invention, makes it possible to dye mixed or blended fabrics much more simply with a wide range of reactive dyestuffs that is possible with conventional processes. The choice of a reactive dye may be constrained by the selection of dyes that are reactive towards the other fibre materials of the blend, but we do not expect this to be a problem to the skilled person. In particular, the pretreatment enables union fabrics of cellulosic fibres, particularly cotton, rayon, and lyocell materials, with polyamide fibres such as wool, silk and nylon to be dyed relatively easily and uniformly. Thus, wool/cotton union fabrics can be uniformly dyed according to the invention using e.g. haloacrylamide, halopyrimidine and vinyl sulphone type reactive dyes. This possibility forms a specific aspect of the invention which accordingly includes a method of dyeing a blend or union fabric containing cellulosic fibres, particularly of cotton, rayon, or lyocell, and polyamide fibres particularly of wool, silk or nylon, which includes the steps of:

1 treating the material with a polymeric pretreatment agent having a plurality of cationic centres and desirably also a plurality of nucleophilic centres;

2 dyeing the material with a reactive dye; and

3 optionally treating the material with a cationic polymer.

The following Examples illustrate the invention, all parts and percentages are by weight unless otherwise stated.

Materials

| | |
|---|---|
| Procion P | ex BASF |
| Procion Red P-4BN | Cl Reactive Red 3:1 |
| Procion Yellow P-3R | Cl Reactive Orange 12 |
| Procion Navy P-2R | |
| Procion Scarlet P-2R | |
| Procion Blue P-3R | Cl Reactive Blue 49 |
| Procion Turquoise P-A | Cl Reactive Blue 71 |
| Procion Black P-2R | |
| Procion Orange P-2R | Cl Reactive Orange 13 |
| Procion H-EXL type | ex BASF |
| Procion Blue H-EXL | Cl Reactive Blue 198 |
| Procion Yellow H-EXL | Cl Reactive Yellow 138 |
| Procion Crimson H-EXL | Cl Reactive Red 231 |
| Procion Red HE-3B | Cl Reactive Red 120 |
| Procion MX type | ex BASF |
| Procion Blue MX-G | Cl Reactive Blue 163 |
| Procion Yellow MX-4G | Cl Reactive Yellow 22 |
| Procion Red MX-8B | Cl Reactive Red 11 |
| Drimalan Type | ex Clariant |
| Drimalan Blue FB | |
| Drimalan Brilliant Red FB | Cl Reactive Red 147 |
| Drimalan Yellow F-3RL | Cl Reactive Yellow 125 |
| Remazol type dyes | ex Dystar (formerly Hoechst) |
| Remazol Red RR | |
| Remazol Yellow RR | |
| Remazol Blue RR | |
| Remazol Black B | Cl Reactive Black 5 |
| Remazol Deep Black N | |
| Sumifix Supra type | Sumifix Supra ex Sumitomo |
| | Yoracron ex Yorkshire Chemicals |
| Sumifix Supra Yellow 3RF, | Cl Reactive Yellow 145 |
| Yoracron Yellow BF-3R | |
| Sumifix Supra Brilliant Red 3BF, | Cl Reactive Red 195 |
| Yoracron Red BF-3B | |
| Sumifix Supra Blue BRF, | Cl Reactive Blue 221 |
| Yoracron Blue BF-R | |
| Kayecelon type | ex Nippon Kayaku |
| Kayacelon Blue CN-BL | Cl Reactive Blue 216 |
| Kayacelon Golden Yellow CN-GL | Cl Reactive Yellow 178 |
| Kayacelon Red CN-3B | Cl Reactive Red 221 |
| Lanasol type | ex Ciba |
| Lanasol Yellow 4G | Cl Reactive Yellow 39 |
| Lanasol Blue 3G | Cl Reactive Blue 69 |
| Lanasol Red 8G | Cl Reactive Red 84 |
| Cibachron Type | ex Ciba |
| Cibachron Yellow C-2R | |
| Cibachron Red C-2G | |
| Cibachron Blue C-R | |
| Cibachron Yellow F-3R | |
| Cibachron Red F-B | |
| Cibachron Blue F-R | |
| Pretreatment agents: | |

| | |
|---|---|
| PT1 | copolymer of allylamine and DADMAC (molar ratio 1:1) |
| PT2 | copolymer of allylamine and DADMAC (molar ratio 3:1) |
| PT3 | poly-(4-vinylpyridine) quatemised (about 75%) with 2-aminoethyl |
| | groups |

Experimental

Pretreatment

Cotton was pretreated with an aqueous solution of the pretreatment agent at 2% (treatment agent as supplied) on the dry fibre weight at 40 to 50° C. for 30 minutes at a liquor ratio of 10:1, followed by rinsing in cold running water. The pretreated fabric was either dried for later use or dyed without further treatment.

On lyocell materials e.g. ‘Tencel’ fabrics made using lyocell fibre made by Courtaulds) the pretreatment was carried out by immersing samples of the ‘Tencel’ fabric (190 g.m⁻²) in an aqueous solution of the pretreatment agent at 2% (of pretreatment agent as supplied) on the dry fabric weight, and further containing 1 g.l⁻¹ Na₂CO₃, at a liquor ratio L:R of 10:1, at 60° C. for 30 minutes. The higher temperature and alkali were used to aid penetration of the inherently more closely packed structure of the lyocell fibre.

On the wool/cotton blend (as used in Example 12), the pretreatment was carried out by immersing samples of the fabrics in an aqueous solution of the pretreatment agent at 2% (of pretreatment agent as supplied) on the dry fabric weight at a liquor ratio L:R of 10:1, at 50° C. for 30 minutes at a pH of about 7.

On the other blends (as used in Example 13), the pretreatment was carried out by immersing samples of the fabrics in an aqueous solution of the pretreatment agent at 2% (of pretreatment agent as supplied) on the dry fabric weight at a liquor ratio L:R of 10:1, at 40 to 50° C. for 30 minutes at a pH of about 7.

Dyeing

The following general method was used:

Wet pretreated cotton (either from the pretreatment step or previously pretreated material dried and then rewetted with water) was placed in dyebath containing 2% dye (as supplied) on the dry fibre weight at room temperature. The temperature was raised to the desired dyeing temperature (usually at the boil, nominally 98° C.) and was held at this temperature for 60 minutes. The dyebath itself was either water (giving a pH of about 6) or buffered at pH 7.4 with a mixed phosphate buffer (very similar results were obtained). The dyeing temperatures varied with the reactive dye type used as is discussed in the Examples. After dyeing the cotton was rinsed in cold running water and dried.

In some cases, dyeing by the standard recommended method was carried out, for comparison.

Wash-off

This was carried out by:

i rinsing in cold running water,

ii rinsing in water at 70° C. for 10 minutes at a liquor ratio of 10:1;

iii rinsing in 80 to 85° C. aqueous Na₂CO₃ solution (1 or 2 g.l⁻¹) for 10 minutes at a liquor ratio of 20:1; or

iv rinsing in 80 to 85° C. aqueous NaHCO₃ solution (5 g.l⁻¹) for 10 minutes at a liquor ratio of 20:1.

Test Methods

NB reference in the Examples to “standard dyeings” refers to dyeings using the same type of reactive dye on the same type of substrate cloth (non pretreated) using conventional dyeing conditions for the dye type on cellulosic substrates.

Wash Fastness

was tested using the ISOC06/C2 (60° C.) wash test to assess the wash fastness of the dyed samples. Numerical scale results are given for grey scale shade change after washing and adjacent staining on other fabrics in test washings.

### EXAMPLE 1

Procion H-EXL type dyes: Procion Blue HEXL, Procion Yellow H-EXL, Procion Crimson H-EXL, Procion Red HE-3B. These are bis-monochlorotriazine dyes and are the most popular and widespread range of reactive dyes for cotton and other cellulosic fibres and their blends. For these dyes the conventional dyeing temperature is about 80° C. at alkaline pH, typically pH 10.8 to 11.2, in this Example the dyeing temperature was 98° C. and the pH 7.4.

The dyeings produced were level, and gave good shades, although having a colour strength lower than standard dyeings on cotton with these dyes; and showing a slight shade change. The fastness of the dyeings on the pretreated cotton was good, much better than for non-washed off standard dyeings, even with a simple rinse as the post dyeing wash. The simple wash off did not give as good a wash fastness result as for (conventionally) fully washed off standard dyeings, but a wash-off in hot water or hot carbonate solution improved the fastness of the pretreated dyeings further. Interestingly those samples that had been pretreated with PT2 had higher colour strength than those pretreated with PT1. This is perhaps surprising given that PT1 has a higher cationic content. The implication is that the fixation of the dye is driving exhaustion.

### EXAMPLE 2

Procion MX type: Procion Blue MX-G, Procion Yellow MX-4G, Procion Red MX-8B. These are low temperature, high reactive dichlorotriazine dyes, normally applied at 30° C. at pH>11, although various methods have been suggested including a lower pH (ca 10) higher temperature (80° C.) procedure. They are typically small lower substantivity dyes that require up to 90 g.l⁻¹ of electrolyte sequentially added to the dyebath to drive exhaustion of the dye onto the fabric.

In this Example they were used dye pretreated cotton at dyeing temperatures of 40 and 98° C. at pH 7.4. Slightly higher colour strengths and fastness were obtained at the higher dyeing temperature, although the fastness was very good for all the dyeings. This compares favourably with the standard dyeings: with only a water rinse the fastness of Blue MX-G is particularly poor. There was only a slight change in shade and brightness.

### EXAMPLE 3

Procion P type dyes: Procion Yellow P-3R, Procion Red P-4BN, Procion Navy P-2R, Procion Scarlet P-2R. Procion Blue P-3R, Procion Turquoise P-A, Procion Black P-2R, Procion Orange P-2R. These are mono-monochlorotriazine dyes that inherently low substantivity and are designed to be used for printing and are not used for conventional long-liquor exhaust dyeing processes. In this Example, dyeings were produced using Procion P dyes at 98° C. on PT2 pretreated cotton. No comparative standard dyeings could be prepared, but comparison with the samples in the dye supplier's pattern card showed that the shades were comparable, even though they were a little flat and less bright For those samples that were tested the fastness was excellent, even with just a cold water rinse following dyeing.

An interesting comparison can be drawn between dyeings made using Cl Reactive Red 3:1 and Cl Reactive Red 120. Molecularly, Red 3:1 is in effect “half” Red 120. As both dyes are based on the same chromophore, the shades produced should be the same. However, we found differences between the respective dyeings. Those produced with Red 3:1 suffered less shade change and possessed excellent fastness, following the simple cold water rinse after dyeing. The conclusion from this is that smaller less substantive dyes can be used in the method of this invention (as shown with Procion MX dyes above), to produce satisfactory dyeings without electrolyte or alkali. It also confirms that exhaustion is being driven by fixation of the dye onto the pretreated textile. Further, the smaller less substantive dyes can be washed off much more easily leading to excellent fastness. The shade change imparted to the smaller dyes is smaller, presumably due to a slightly different packing arrangement of the less substantive dyes in the fibre.

### EXAMPLE 4

Remazol type dyes: Remazol Red RR, Remazol Yellow RR, Remazol Blue RR, Remazol Black B. These are an important class of reactive dyes, second only to the triazine based dyes. They are normally applied at a dyeing temperature of 60° C. at a pH>11. The RR dyes are the latest products in the range and Black B is the biggest selling reactive dye in the world. In this Example the dyes were applied at a dyeing temperature of 98° C. and for Black B also at 60° C.

The results were similar to those obtained with Procion H-EXL type dyes in that the dyeings produced were level and deep, though of slightly lower colour strength than their conventionally applied counterparts, with a slight during of the shade. The fastness of the preteated sample dyed with Black B was excellent even with only a cold water rinse following dyeing. The slight shade change imparted by the pretreatment was less noticeable for the darker colour. There was a slight difference in the dyeings at the two temperatures, for Black B; the higher temperature application resulted in slightly higher colour strength and visually improved fastness.

### EXAMPLE 5

Lanasol type dyes: Lanasol Yellow 4G, Lanasol Blue 3G, Lanasol Red 6G. The Lanasol range of reactive dyes, is a small but successful range aimed specifically at wool dyeing. Conventionally, they are not used for cotton as they have virtually no substantivity towards cellulosic fibres. They can be applied to wool at 80, 98 or 105° C., pH 4-6, without suffering dye hydrolysis. In this Example, they were applied at 2% omf to PT2 pretreated cotton at 98° C. The dyeings produced were excellent in terms of depth of shade and brightness. The fastness was also very good to excellent; a rinse in water at 70° C. or using a 1 g.l⁻¹ aqueous Na₂CO₃ solution, was required to maximise the fastness of Blue 3G and Red 6G.

### EXAMPLE 6

Drimarene/Drimalan type dyes: Drimalan Blue FB, Drimalan Brilliant Red FB, Drimalan Yellow F-3RL - Drimarene and Drimalan dyes are sold for cellulose and wool reactive dyeing respectively. Essentially they are the same chemically, based on chlorodifluoropyrimidine reactive groups (some are trichloropyrimidines of slightly lower reactivity). These dyes are intermediate in reactivity to dichloro- and monochlorotriazine types. They are applied to cotton at temperatures above 60° C. at pH>11. In this Example Drimalan Blue FB was applied to PT1 pretreated cotton at 60° C. and all three Drimalan type dyes to PT2 pretreated cotton at 98° C. The dyeings produced were level and of good colour strength with excellent fastness.

### EXAMPLE 7

Kayacelon React type dyes: Kayacelon Blue CN-BL, Kayacelon Red CN-3B=Cl Reactive Red 221, Kayacelon Golden Yellow CN-GL. Kayacelon Reacts are nicotinic acid derivatives of monochlorotriazine dyes. Their main advantage over conventional cellulosic reactive dyes is that they are neutral fixing, being conventionally applied with electrolyte, pH 7.4 buffer (or at other pH's in the range 6 to 8) at 98° C. In this Example, the dyes were applied at the boil to PT2 pretreated cotton. The dyeings produced were level, of similar colour strength to the standards, although there was a shade change.

### EXAMPLE 8

Sumifix Supra type dyes: Yoracron Yellow BF-3R, Yoracron Red BF-3B, Yoracron Blue BF-R. These dyes are hetro-bifunctional reactive dyes; effectively dichlorotriazine dyes derivatised with a vinyl sulphone precursor. They contain mono-vinylsulphone and monochloroine reactive groups and can be applied at temperatures of 60° C. and above at a typical pH>11. In this Example, the dyes were applied at 98° C. to PT2 pretreated cotton. The shades produced were deep and level, but with a slight hue change and flattening compared to the standard dyeings.

### EXAMPLE 9

Example 1 was repeated for Cl Reactive Red 120 dyeing, except that the pretreatment agent used was PT3 and the dyeing temperature used was 98° C. Deep level dyeings were produced, although they were duller, flatter and less bright than the standard dyeing. The fastness was very good, even with only a cold water rinse, indicating that reaction had occurred between the dye and the polymer.

### EXAMPLE 10

Example 4 was repeated for Cl Reactive Black 5 dyeing, except that the pretreatment agent used was PT3 and the dyeing temperature used was 98° C. Deep, level dyeings were produced that were slightly duller than the original, with excellent fastness. The shade change was not very significant given the dark shade of the dye.

### EXAMPLE 11

Example 2 was repeated except that the dye used was using Procion Yellow MX-3R=Cl Reactive Orange 86, the pretreatment agent used was PT3 and the dyeing temperature used was 98° C. The dyeings produced were deep and level with excellent fastness. The dye itself when applied conventionally is an orange shade of yellow. The pretreated and dyed samples appeared more orange due to a darkening of the shade. In general the dyeings on PT3 pretreated cotton gave more shade change and dulling than those treated with PT1 and PT2.

### EXAMPLE 12

This Example illustrates the dyeing of cellulosic fibre/wool blends (lyocell/wool blends) using, Cl Reactive Red 169, a reactive pre-metallized dye after pretreatment with PT1. Table 1 below shows colorimetric and Wash Fastness data for the dyed fabric.

TABLE 1

| | | | | | | | Wash Fastness | | |
|---|---|---|---|---|---|---|---|---|---|
| | Pre- | | | | | | | adjacent | |
| Sam- | treatment | | Colorimetric data | | | | shade | staining | |
| ple | matl | % | L* | a* | b* | K/S | change | cotton | nylon |
| 12C | — | — | 40.34 | 28.27 | −5.49 | 5.46 | 4/5 | 4/5 | 5 |
| 12.1 | PT1 | 2 | 35.41 | 30.43 | −5.51 | 8.39 | 4/5 | 4-4/5 | 4/5-5 |

The data show the effect of the pretreatment—in samples without pretreatment the wool portion dyed successfully, whilst the lyocell only stained and the resultant dyeings were dearly mottled; the samples that had been pretreated were coloured far more uniformly and to a deeper depth. The Wash Fastness ratings of the dyeings were good, but were measured on dyeings that had not been washed off after dyeing. A wash off e.g. with aqueous NaHCO₃ (5 g.l⁻¹) at 80 to 85° C., would improve the wash fastness to excellent. The appearance of reduced numerical Fastness ratings for the pretreated samples arises from the much greater colour depth achieved on the cellulosic portion of the blend in these samples. (It is well known that pre-metallized dyes possess high fastness on wool, as can be seen from the data on the non-pretreated sample fastness data in the Table, in which only the wool portion was dyed.)

### EXAMPLE 13

The dyeings of Example 12 on fibre blend fabrics were extended to other fabrics and other dyes. Fibre blend fabrics were made up with the following materials: velour (nylon/cotton), cotton/silk, linen/silk and hemp/cotton/wool. The fabrics were pretreated with PT1 at described above and samples were then dyed with Lanasol Red 6G, Lanasol Yellow 4G and Lanasol Blue 3G. The dyeing conditions were that the temperature was raised to 98° C. at a rate of 2° C.min⁻¹ and held at 98° C. for 60 minutes and the dyeings were washed off with aqueous NaHCO₃ (5 g.l⁻¹) at 80 to 85° C., rinsed and dried. The pretreated fabrics dyed to give uniform dyeings of a deeper shade than non-pretreated controls. For the first three mixed fibre fabrics, the fibre blends were intimate enough that the control dyeings looked uniform, but the dyeings on the pretreated fabrics were of a much deeper shade. For the hemp/cotton/wool mixed fabric, the control dyeing looked mottled, whereas the dyeings on the pretreated fabric were uniform and of a much deeper shade. Wash Fastness testing gave similar results to those on viscose/wool and lyocell/wool mixtures described in Example 12.

### EXAMPLE 14

Example 13 was extended to other dye types:

Procion P: Procion Yellow P-3R, Procion Red P4BN and Procion Navy P-2R

Sumifix Supra: Yoracron Yellow BF-3R, Yorecron Red BF-3B and Yoracron Blue BF-R

The dyeings were carried out as described in Example 13 and gave similar results in terms of depth of shade and wash fastness.

### EXAMPLE 15

Further fabrics, cotton and cotton/wool and cotton/nylon welour, were dyed by the general method described in Example 12, but using pretreatment agent PT2. The treated fabrics were dyed with a range of reactive dyes and the fabrics washed. The cotton and velour samples were washed using wash routine iii (see methods section above) but for 15 to 20 minutes, and the cotton/wool blend using wash routine iv (see methods section above) but for 15 to 20 minutes. All the pretreated samples gave good fast dyeings. Colourimetric and wash test data for these samples is set out in Table 2 below.

TABLE 2

| | | | | | | Wash Fastness | | |
|---|---|---|---|---|---|---|---|---|
| Run | | Colorimetric data | | | | shade | staining | |
| No | Dye | L* | a* | b* | K/S | change | cotton | nylon |

Part A - Cotton substrate

| | | | | | | | | |
|---|---|---|---|---|---|---|---|---|
| 14.1 | Procion Yellow P-3R | 72.1 | 28.6 | 59.9 | 4.7 | 5 | 5 | 5 |
| 14.2 | Procion Red P-4BN | 50.6 | 52.1 | −2.0 | 5.4 | 5 | 5 | 5 |
| 14.3 | Procion Navy P-2R | 39.2 | −2.1 | −15.0 | 5.3 | 5 | 5 | 5 |
| 14.4 | Procion Yellow H-EXL | 66.6 | 35.0 | 52.0 | 4.7 | 5 | 5 | 5 |
| 14.5 | Procion Brilliant Red H-EXGL | 50.1 | 49.3 | −0.2 | 5.2 | 5 | 5 | 5 |
| 14.6 | Procion Blue H-EXL | 45.9 | −2.3 | −33.5 | 5.0 | 5 | 5 | 5 |
| 14.7 | Procion Yellow MX-4G | 82.4 | 6.1 | 70.2 | 4.3 | 5 | 5 | 5 |
| 14.8 | Procion Red MX-8B | 40.3 | 45.0 | −8.7 | 8.4 | 5 | 5 | 5 |
| 14.9 | Procion Blue MX-G | 38.6 | −6.9 | −29.5 | 9.6 | 5 | 5 | 5 |
| 14.10 | Drimalan Yellow F-3RL | 67.2 | 29.6 | 57.9 | 6.2 | 5 | 4/5 | 5 |
| 14.11 | Drimalan Brilliant Red FB | 47.6 | 48.4 | −5.2 | 5.8 | 5 | 5 | 5 |
| 14.12 | Drimalan Blue FB | 46.5 | −4.4 | −29.2 | 4.5 | 5 | 5 | 4/5 |
| 14.13 | Remazol Deep Black N | 23.3 | −0.1 | −5.0 | 7.2 | 5 | 5 | 5 |
| 14.14 | Remazol Yellow RR | 71.5 | 30.2 | 62.9 | 5.5 | 5 | 5 | 5 |
| 14.15 | Remazol Red RR | 45.3 | 54.6 | 1.7 | 9.5 | 5 | 5 | 5 |
| 14.16 | Remazol Blue RR | 36.5 | −6.7 | −18.7 | 8.7 | 5 | 5 | 5 |
| 14.17 | Sumifix Supra Yellow 3RF | 67.3 | 34.4 | 55.0 | 5.1 | 5 | 5 | 5 |
| 14.18 | Sumifix Supra Red 3BF | 42.8 | 43.2 | −1.6 | 7.3 | 5 | 5 | 5 |
| 14.19 | Sumifix Supra Blue BRF | 34.3 | −2.7 | −15.0 | 7.8 | 5 | 5 | 5 |
| 14.20 | Kayacelon Golden Yellow CN-GL | 66.7 | 33.3 | 54.0 | 5.2 | 4/5 | 4 | 5 |
| 14.21 | Kayecelon Red CN-3B | 48.5 | 40.7 | 0.0 | 5.7 | 5 | 4/5 | 5 |
| 14.22 | Kayacelon Blue CN-BL | 46.8 | −0.8 | −27.1 | 4.1 | 4/5 | 4/5 | 5 |
| 14.23 | Lanasol Yellow 4G | 85.6 | −2.1 | 68.3 | 4.7 | 5 | 5 | 5 |
| 14.24 | Lanasol Red 8G | 52.0 | 45.2 | 23.9 | 6.3 | 5 | 5 | 5 |
| 14.25 | Lanasol Blue 3G | 45.1 | −9.9 | −23.7 | 5.3 | 5 | 5 | 5 |
| 14.26 | Cibachron Yellow C-2R | 69.9 | 31.8 | 57.6 | 4.9 | 5 | 5 | 5 |
| 14.27 | Cibachron Red C-2G | 42.8 | 44.5 | −0.4 | 7.8 | 5 | 5 | 5 |
| 14.28 | Cibachron Blue C-R | 41.6 | 1.0 | −27.4 | 5.5 | 4/5 | 5 | 5 |
| 14.29 | Cibachron Yellow F-3R | 72.5 | 28.4 | 58.8 | 4.4 | 5 | 5 | 5 |
| 14.30 | Cibachron Red F-B | 46.4 | 40.8 | −8.3 | 5.9 | 5 | 5 | 5 |
| 14.31 | Cibachron Blue F-R | 47.4 | −0.5 | −27.3 | 3.9 | 5 | 5 | 5 |

Part B - Cotton/wool substrate

| | | | | | | | | |
|---|---|---|---|---|---|---|---|---|
| 14.32 | Procion Yellow P-3R | 67.5 | 28.5 | 60.1 | 6.6 | 5 | 4/5 | 5 |
| 14.33 | Procion Red P-4BN | 44.9 | 53.3 | 2.5 | 9.1 | 5 | 5 | 5 |
| 14.44 | Procion Navy P-2R | 39.2 | 2.1 | −15.7 | 4.5 | 5 | 5 | 5 |
| 14.35 | Drimalan Yellow F-3RL | 64.8 | 32.2 | 66.2 | 10.7 | 5 | 4 | 5 |
| 14.36 | Drimalan Brilliant Red FB | 46.6 | 45.3 | −2.4 | 5.7 | 5 | 5 | 5 |
| 14.37 | Drimalan Blue FB | 35.4 | −2.0 | −32.2 | 10.8 | 5 | 5 | 4/5 |
| 14.38 | Remazol Deep Black N | 23.6 | 2.4 | −2.1 | 12.5 | 5 | 5 | 5 |
| 14.39 | Remazol Yellow RR | 63.3 | 34.6 | 58.9 | 8.2 | 5 | 4/5 | 5 |
| 14.40 | Remazol Red RR | 39.5 | 45.0 | −0.4 | 10.0 | 5 | 5 | 5 |
| 14.41 | Remazol Blue RR | 27.5 | −2.6 | −15.4 | 13.6 | 5 | 5 | 5 |
| 14.42 | Sumifix Supra Yellow 3RF | 63.9 | 32.7 | 57.8 | 7.4 | 5 | 4/5 | 5 |
| 14.43 | Sumifix Supra Red 3BF | 40.3 | 44.7 | −0.8 | 9.2 | 5 | 5 | 5 |
| 14.44 | Sumifix Supra Blue BRF | 29.4 | −3.1 | −15.2 | 11.7 | 5 | 5 | 5 |
| 14.45 | Lanasol Yellow 4G | 80.7 | −0.6 | 73.6 | 7.7 | 5 | 5 | 5 |
| 14.46 | Lanasol Red 8G | 46.5 | 48.4 | 28.1 | 11.2 | 5 | 5 | 5 |
| 14.47 | Lanasol Blue 3G | 37.2 | −9.5 | −25.7 | 9.9 | 5 | 5 | 5 |
| 14.48 | Cibachron Yellow C-2R | 68.7 | 23.8 | 45.1 | 3.2 | 5 | 5 | 5 |
| 14.49 | Cibachron Red C-2G | 39.9 | 45.9 | 0.7 | 10.3 | 5 | 5 | 5 |
| 14.50 | Cibachron Blue C-R | 42.2 | −0.2 | −24.2 | 5.1 | 4/5 | 4/5 | 5 |
| 14.51 | Cibachron Yellow F-3R | 69.6 | 26.2 | 55.9 | 4.8 | 5 | 5 | 4/5 |
| 14.52 | Cibachron Red F-B | 46.0 | 40.6 | −5.5 | 5.2 | 5 | 5 | 4/5 |
| 14.53 | Cibachron Blue F-R | 48.3 | −1.5 | −20.2 | 3.1 | 5 | 5 | 4/5 |

Part C - Cotton/nylon substrate

| | | | | | | | | |
|---|---|---|---|---|---|---|---|---|
| 14.54 | Procion Yellow P-3R | 72.6 | 23.8 | 54.9 | 3.8 | 5 | 4/5 | 5 |
| 14.55 | Procion Red P-4BN | 50.1 | 52.6 | −0.8 | 5.9 | 4/5 | 5 | 5 |
| 14.56 | Procion Navy P-2R | 41.9 | −2.4 | −15.0 | 4.5 | 5 | 5 | 5 |
| 14.57 | Drimalan Yellow F-3RL | 67.3 | 31.0 | 66.5 | 9.1 | 5 | 4/5 | 5 |
| 14.58 | Drimalan Brilliant Red FB | 48.2 | 50.8 | −4.2 | 6.1 | 4/5 | 5 | 4/5 |
| 14.59 | Drimalan Blue FB | 44.7 | −5.3 | −29.9 | 5.4 | 5 | 5 | 5 |
| 14.60 | Remazol Deep Black N | 22.6 | −1.1 | −6.9 | 12.1 | 5 | 5 | 5 |
| 14.61 | Remazol Yellow RR | 65.3 | 34.4 | 58.8 | 6.4 | 5 | 4/5 | 5 |
| 14.62 | Remazol Red RR | 42.0 | 45.8 | −1.8 | 8.3 | 5 | 5 | 5 |
| 14.63 | Remazol Blue RR | 33.9 | −4.2 | −16.0 | 8.8 | 5 | 5 | 5 |
| 14.64 | Sumifix Supra Yellow 3RF | 65.6 | 34.0 | 57.7 | 6.6 | 5 | 4/5 | 5 |
| 14.65 | Sumifix Supra Red 3BF | 41.0 | 45.7 | −1.6 | 8.9 | 5 | 5 | 5 |
| 14.66 | Sumifix Supra Blue BRF | 28.9 | −3.9 | −16.1 | 13.2 | 5 | 5 | 5 |
| 14.67 | Lanasol Yellow 4G | 81.5 | −1.2 | 74.4 | 6.9 | 5 | 5 | 5 |
| 14.68 | Lanasol Red 8G | 48.5 | 49.2 | 26.6 | 9.6 | 5 | 5 | 5 |
| 14.69 | Lanasol Blue 3G | 42.6 | −10.6 | −25.0 | 6.8 | 5 | 5 | 5 |
| 14.70 | Cibachron Yellow F-3R | 73.2 | 24.6 | 59.8 | 4.4 | 5 | 5 | 4/5 |
| 14.71 | Cibachron Red F-B | 46.2 | 46.0 | −7.6 | 6.0 | 5 | 5 | 4/5 |
| 14.72 | Cibachron Blue F-R | 48.5 | −1.6 | −26.1 | 3.6 | 4/5 | 5 | 5 |

1. A method of making a dyed cellulosic fibrous textile material, which includes the steps of:
1 treating the material with a polymeric pretreatment agent having a plurality of cationic centres and optionally also a plurality of nucleophilic centres;
2 dyeing the material with a reactive dye; and
3 optionally treating the material with a cationic polymer.

2. A method as claimed in claim 1 wherein the cellulosic fibrous material contains from 30 to 100% of natural, synthetic or regenerated cellulosic fibres or blends of such materials.

3. A method as claimed in claim 2 wherein the natural cellulosic fibrous material is cotton, flax, jute, hemp and/or ramie; and the synthetic or regenerated cellulosic fibrous material is rayon and/or a lyocell material.

4. A method as claimed in any one of claims 1 to 3 wherein the fibrous material is a blend of one or more cellulosic fibres with non cellulosic fibrous material.

5. A method as claimed in claim 4 wherein the fibrous non-cellulosic material is a polyethylene terephthalate polymer or related copolymer, and/or a wool, silk and/or synthetic polyamide fibre.

6. A method as claimed in any one of claims 1 to 3 wherein the fibrous material is a union fabric of cotton, rayon, and/or lyocell materials, with wool, silk and/or nylon polyamide fibres.

7. A method as claimed in any one of claims 1 to 6 wherein the polymeric pretreatment agent contains a plurality of cationic centres and a plurality of nucleophilic centres and wherein the nucleophilic centres include primary aliphatic amino groups and/or secondary aliphatic amino groups.

8. A method as claimed in any one of claims 1 to 7 wherein the polymeric pretreatment agent contains a plurality of cationic centres and a plurality of nucleophilic centres and wherein the concentration of the nucleophilic centres (expressed as nucleophilic centres per units of molecular weight) of from 1 nucleophilic centre per 60 Daltons to 1 nucleophilic centre per 1500 Daltons.

9. A method as claimed in any one of claims 1 to 8 wherein the polymeric pretreatment agent contains poly-quaternary nitrogen centres which are of the formula —N⁺(R)₃ where each R is an alkyl group; or where two of the groups R together with the nitrogen atom bearing them form a 5 or 6 membered heterocyclic ring; or —N⁺(R′)₂- where the groups R′ are as defined for R above and the other bonds directly or indirectly link into the polymer chain optionally via a 5- or 6-membered ring; and/or aromatic quaternary nitrogen centres.

10. A method as claimed in any one of claims 1 to 9 wherein the polymeric pretreatment agent has a degree of cationicity (expressed as cationic centres per units of molecular weight) of from 1 cationic centre per 180 Daltons to 1 cationic centre per 1500 Daltons.

11. A method as claimed in any one of claims 1 to 6 wherein the polymeric pretreatment agent contains a plurality of primary aliphatic amino nucleophilic centres at a concentration of nucleophilic centres (expressed as nucleophilic centres per units of molecular weight) of from 1 nucleophilic centre per 100 Daltons to 1 nucleophilic centre per 1000 Daltons and a plurality of quaternary amino cationic centres a concentration of cationic centres (expressed as cationic centres per units of molecular weight) of from 1 cationic centre per 200 Daltons to 1 cationic centre per 1000 Daltons.

12. A method as claimed in any one of claims 1 to 11 wherein the polymeric pretreatment agent has a molecular weight of from 5 to 50 kD.

13. A method as claimed in any one of claims 1 to 12 wherein the polymeric pretreatment agent is a copolymer of diallyidimethylammonium chloride and ethylenically unsaturated monomers containing a primary amino group; poly(N-methyl-N-(aminoalkyl) diallylammonium, where the aminoalkyl group is 2-aminoethyl or 3-aminopropyl; polymers of vinylpyridine quaternised with alkyl groups, containing a primary amino group; and copolymers having repeat units of diallylmethylamine (or its protonated ammonium derivative) and diallyl-2-hydroxyl-3-choropropyl amine (or its protonated ammonium derivative).

14. A method as claimed in any one of claims 1 to 13 wherein the reactive dye is one or more dye including at least one reactive group or residue selected from a triazine residue carrying at least one halogen and/or at least one N-linked nicotinic acid leaving group; a halogen substituted pyrimidine group; a vinyl sulphone group; and a halogen substituted acrylamido group.

15. A method as claimed in claim 14 wherein the reactive group(s) or residue(s) in the dye is/are one or two monochloro cyanuryl chloride residue(s); a difluorochloropyrinidyne residue; one or two β-sulphatovinyl sulphone group(s); a monochloro cyanuryl chloride residue and a β-sulphatovinyl sulphone group; one or two N-linked nicotinic acid substituted 2,4,6-trichloro-sym-triazinyl residue(s); or an a-bromoacrylamido group.
